(19) United States
(12) Patent Application Publication
(10) Pub. No.: US 2020/0111327 A1
(43) Pub. Date: Apr. 9, 2020

(54) SYNCHRONIZED REEL OUTCOMES IN REEL GAMES

(71) Applicant: Everi Games, Inc., Austin, TX (US)

(72) Inventor: Brian A. Watkins, Austin, TX (US)

(73) Assignee: Everi Games, Inc., Austin, TX (US)

(21) Appl. No.: 16/152,381

(22) Filed: Oct. 4, 2018

(51) Int. Cl. G07F 17/34; G07F 17/32

(52) U.S. Cl. CPC G07F 17/34; G07F 17/3209; G07F 17/3244; G07F 17/3213

(57) ABSTRACT

A gaming system, apparatus, and method are disclosed providing synchronized reel movement in wagering games played on slot machines or other gaming machines. A synchronized game outcome is provided in which slot reels rotate in a synchronized fashion at a slow rate, allowing the player to observe potential reel stop combinations passing over the game display. Processes for implementing the synchronization are provided for mechanical and simulated reels.

### FIELD OF THE INVENTION

This invention relates to gaming systems and to gaming machines through which players may participate in wagering games, and in particular slot machine games with a feature game that provides accumulating persistent events.

### BACKGROUND

Many different types of gaming machines have been developed to provide various formats and graphic presentations for conducting games and presenting game results. For example, numerous mechanical reel-type gaming machines, also known as slot machines, have been developed with different reel configurations, reel symbols, and paylines. More recently, gaming machines have been developed with video monitors that are used to produce simulations of mechanical spinning reels. These video-based gaming machines may use one or more video monitors to provide a wide variety of graphic effects in addition to simulated spinning reels, and may also provide secondary/bonus games using different reel arrangements or entirely different graphics. Many video-based gaming machines have three or five spinning reels that may be stopped to display a matrix of game symbols. The symbols displayed on the stopped reels correlate to a result of the game. Video-based gaming machines may also be used to show card games or various types of competitions such as simulated horse races in which wagers may be placed.

Game manufacturers are continuously pressed to develop new game presentations, formats, and game graphics in an attempt to provide high entertainment value for players and thereby attract and keep players. One such improvement is the use of features that attract a player's attention to anticipate a certain result while the game is being conducted. For example, popular “wheel spin” games generate excitement using a large wheel which players can view spinning and anticipate winning outcomes. Such games are very popular, but require a large mechanical wheel structure associated with a bank of gaming machines, or a large group display having the same effect. What is needed are ways to provide both anticipation and excitement to players in playing with such anticipatory features.

### SUMMARY OF THE INVENTION

The present invention includes wagering games, gaming machines, networked gaming systems that provide improvements to games played on slot machines or other gaming machines.

According to one aspect of the invention, a method of providing wagering game method is provided. The method is conducted under control of one or more electronic processors to present gaming results on one or more displays on a gaming machine. The method includes receiving a wager activation on a player input device at the gaming machine and, in response, conducting a game round concluding with a game result in which a matrix of symbol locations displayed on one of the displays is populated with randomly selected symbols presented on simulated reels or mechanical reels, the game result including a possibility of winning credits and a possibility of activating a synchronized game outcome. The method provides a synchronized game outcome by determining a set of reel stop locations for all reels in the display, determining reel offsets for one or more of the reels, applying the reel offsets to place the reels in a desired position for synchronized spinning. Next, the synchronized game outcome includes performing a synchronized spin of the reels including moving all reels at the same speed and with symbols moving in synchronized parallel rows, while performing the synchronized spin, moving the reels at a velocity of less than three symbols per second. Then, the synchronized game outcome includes stopping the reels in synchronized parallel rows to rest at the reel stop locations, evaluating the matrix of symbol locations.

According to some embodiments, the method may include performing a normal, unsynchronized reel spin before performing the synchronized reel spin. The unsynchronized reel spin may transition without stopping the reels to the synchronized reel spin by applying the offsets while the reels are moving and then slowing the reels.

According another aspect of the invention a gaming machine is provided a display system including one or more displays, a player input system, at least one processor operably connected to the display system and player input system; and at least one memory device operably connected to the processor and storing program code executable by the at least one processor to perform processes of the game. The program code is executable for receiving a wager activation on a player input device at the gaming machine, and, in response, conducting a game round concluding with a game result in which a matrix of symbol locations displayed on one of the displays is populated with randomly selected symbols presented on simulated reels or mechanical reels, the game result including a possibility of winning money value credits and a possibility of activating a synchronized game outcome. The program code is also executable for determining a set of reel stop locations for all reels in the display and determining reel offsets for one or more of the reels. It then applies the reel offsets to place the reels in a desired position for synchronized spinning. Next, the program code performs a synchronized spin of the reels including moving all reels at the same speed and with symbols moving in synchronized parallel rows. While performing the synchronized spin, the executing program moves the reels at a velocity of less than three symbols per second. Next, it stops the reels in synchronized parallel rows to rest at the reel stop locations evaluates the matrix of symbol locations.

According to some embodiments, the program code may also include code for performing a normal, unsynchronized reel spin before performing the synchronized reel spin. The unsynchronized reel spin may transition without stopping the reels to the synchronized reel spin by applying the offsets while the reels are moving and then slowing the reels.

Another aspect of the invention is a computer program stored on a non-transitory readable medium. The software version is, of course, typically designed to be executed by a gaming machine or networked gaming system. The software includes multiple portions of computer executable code referred to as program code. Gaming results are provided in response to a wager and displayed by display program code that generates simulated slot reels each including one or more symbol locations. The program also has game controller program code for determining game play results involving spins or other randomization of an array of symbols, and providing the feature game selection method or the wheel enhancement feature game mode and its animations.

Another aspect of the invention is a gaming system that includes one or more gaming servers, and a group of electronic gaming machines connected to the servers by a network, programmed to provide one of more of the methods described herein. The various functionality described herein may be distributed between the electronic gaming machines and the gaming servers in any practically functional way. For example, the current preferred architecture is for the servers to determine all aspects of game logic, random number generation, and prize awards. The gaming machines provide functionality of interfacing with the player and animating the game results to present the results received from the server in an entertaining manner. However, other embodiments of course might use a thin client architecture in which the animation is also conducted by the server and electronic gaming machines serve merely as a terminal to receive button or touchscreen input from the player and to display graphics received from the server.

Different features may be included in different versions of the invention. These and other advantages and features of the invention will be apparent from the following description of the preferred embodiments, considered along with the accompanying drawings.

### BRIEF DESCRIPTION OF THE DRAWINGS

FIG. 1A-C show a series of game screen diagram illustrating a game presentation on a primary display of an example slot machine.

FIG. 2 is a perspective diagram of a mechanical reel assembly that may be employed to provide a gaming display according to one or more embodiments.

FIG. 3 is a flowchart showing a process for providing a synchronized game outcome according to one or more embodiments of the invention.

FIG. 4 is a diagram showing data structures and reel positions involved in calculating offsets according to one or more embodiments.

FIG. 5 is a front perspective view of a gaming machine which may be used in a gaming system embodying the principles of the present invention.

FIG. 6 is a block diagram showing various electronic components of the gaming machine shown in FIG. 5 together with additional gaming system components.

FIG. 7 is a system block diagram of a gaming system according to another embodiment of the invention.

### DETAILED DESCRIPTION OF PREFERRED EMBODIMENTS

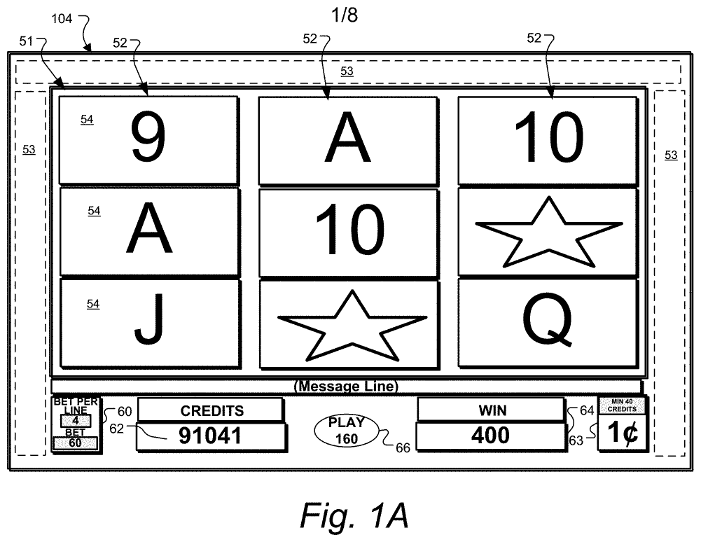

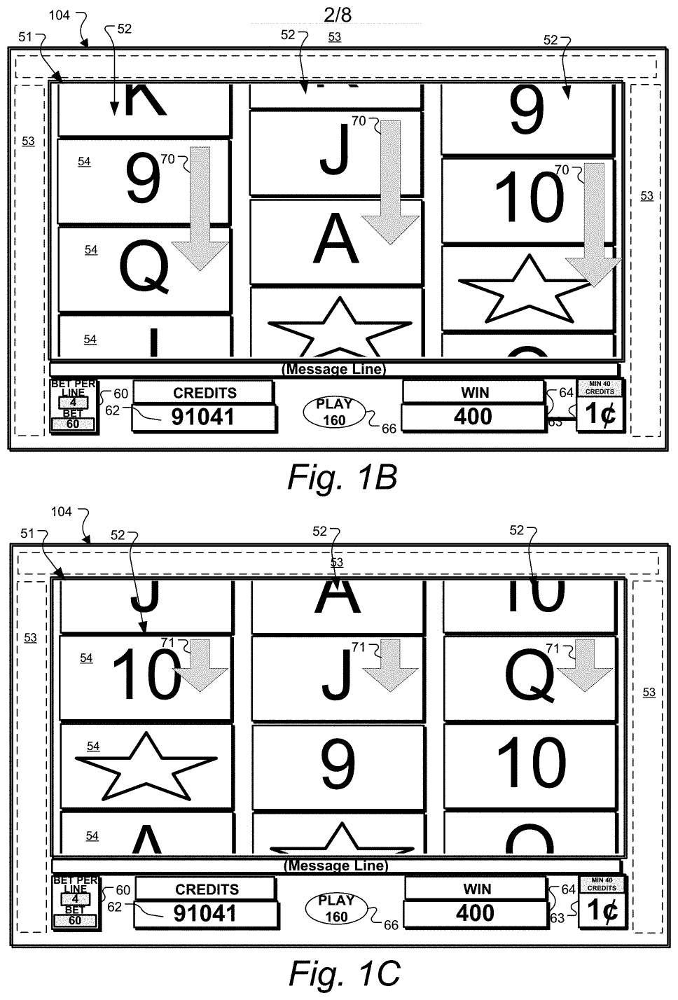

FIG. 1A-C show a series of game screen diagram illustrating a game presentation on a primary display 104 of an example slot machine on which wagering games or slot machine games are provided. A reel-type game is presented through a gaming area of the display, in this version a matrix 51 of symbol locations 54 arranged in rows and columns to represent simulated slot machine reels that are spun to conduct a game round. Around matrix 51 are presented background, side, and top graphics 53, which may be animated during or between games as part of a multimedia theme. Other embodiments may, of course, use other types of game displays to display randomizing of symbols according to the methods herein. The depicted reels 52 of symbols may be provided by simulated reels, or by mechanical reels having window allowing visibility of the depicted symbols in a gaming area according to known slot machine designs. In this version there are three reels with three symbol locations 54 displayed at a time on each reel, but the game can be played with more and less reels. The simulated or mechanical reel typically has far more symbols than those displayed, and as many unique stop positions as there are symbols on the simulated reel. The stop position may be counted, for example, by numbering the symbols on the reel and using the number of the symbol at the bottom of the display window (the three symbols displayed in this example), or at the top or middle. Surrounding the matrix 51 is background graphics 53, which may be above, beside, below, between or behind the symbol locations 54 of matrix 51.

Winning patterns are typically formed by matching symbols along defined paylines that pass through the matrix 51. Box 60, which displays the current wager and amount bet per payline. Other versions may not have a designated bet per line. To the right of box 60 is box 62, which displays the current credits in the player's account. In the bottom center a touchscreen play button 66 is presented in the lower central area of the display, which may show other game state related graphics. Right of this is win box 64, which displays the player's last awarded winnings. The wager credit denomination is shown in box 63. Along the bottom edge of the matrix 51 there is a message line, where the game station can display further instructions to the player.

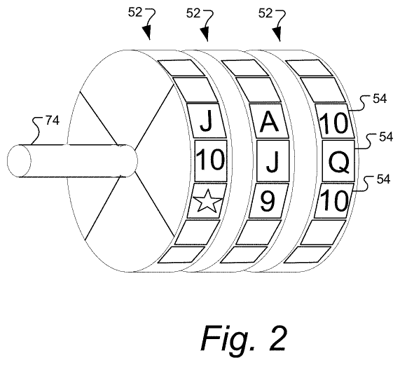

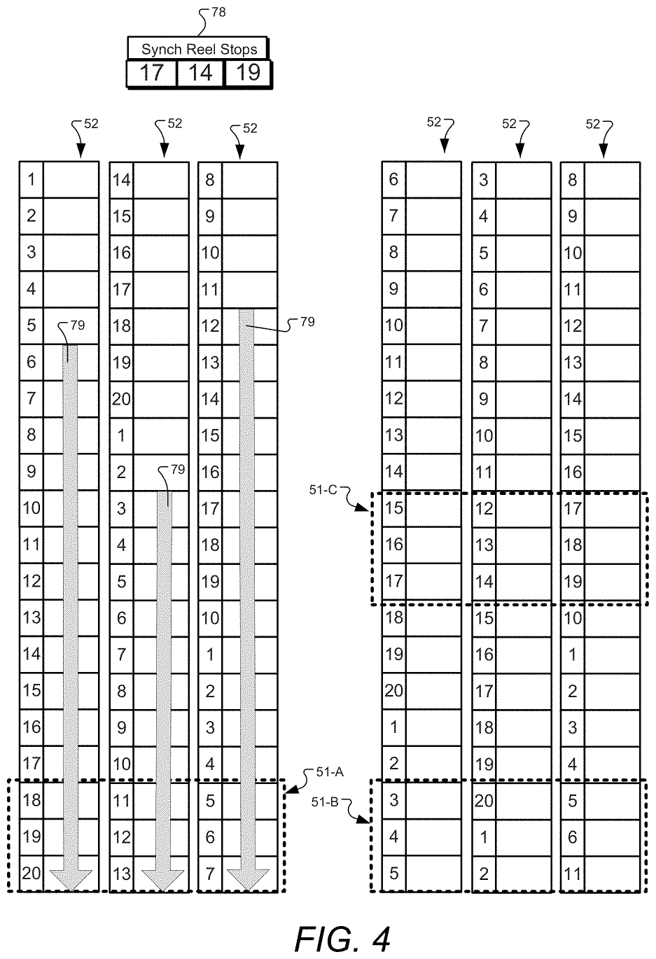

The series of screen diagrams of FIGS. 1A-C will be further described with respect to the process flow chart of FIG. 4. FIG. 2 is a perspective diagram of a mechanical reel assembly that may be employed to provide a gaming display according to one or more embodiments. In this version three mechanical reels 52 are arranged along a central axis 74. The reels are typically rotated independently by dedicated stepper motors for each reel. Such a mechanical reel display may be employed with the techniques herein.

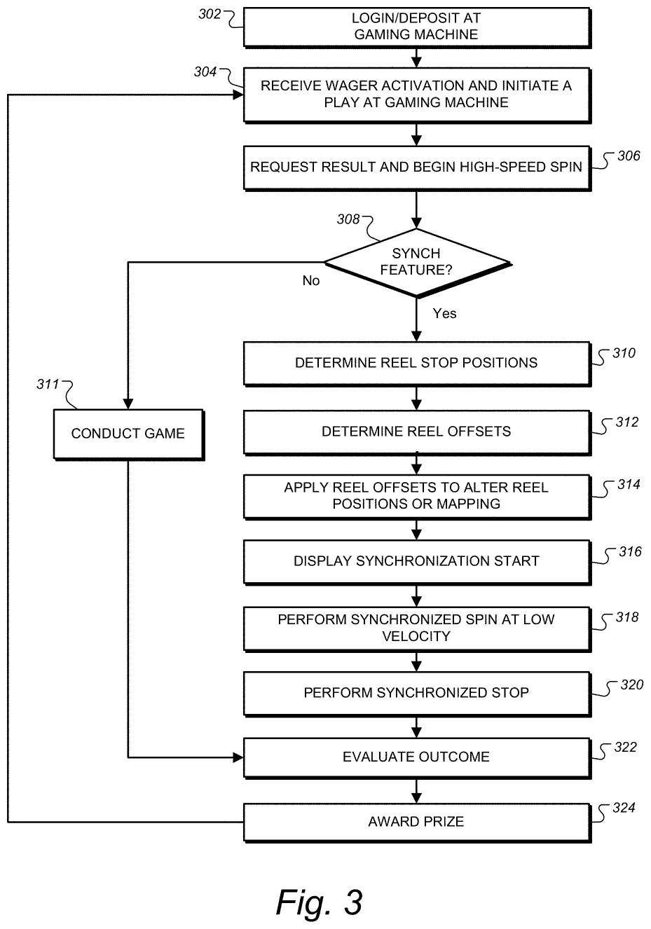

FIG. 3 is a flowchart showing a process for providing a synchronized game outcome according to one or more embodiments of the invention. Generally, the process is a method of providing a wagering game, the method conducted under control of one or more electronic processors to present gaming results on one or more displays on a gaming machine such as those described below. While the process blocks are shown in order, this is not limiting and often the processor instructions for one particular process block will execute in parallel to those of another. The process starts at block 302 where a player logs in or deposits money or a credit voucher at a gaming machine. To begin a game play, the process receives a wager activation on a player input device at the gaming machine at block 304, which typically consists of some input from the player to set the amount to be wagered from their credit amount on the machine. The wager amount may also be carried over from previous game rounds by simply starting the game with the previous wager amount set. This typically happens through a ‘Play’ button on the game cabinet or touchscreen display, and serves to place the wager and start a single round of game play. At this point the gaming display holds a prior result on the matrix 51 of symbol locations 54, like that of FIG. 1A.

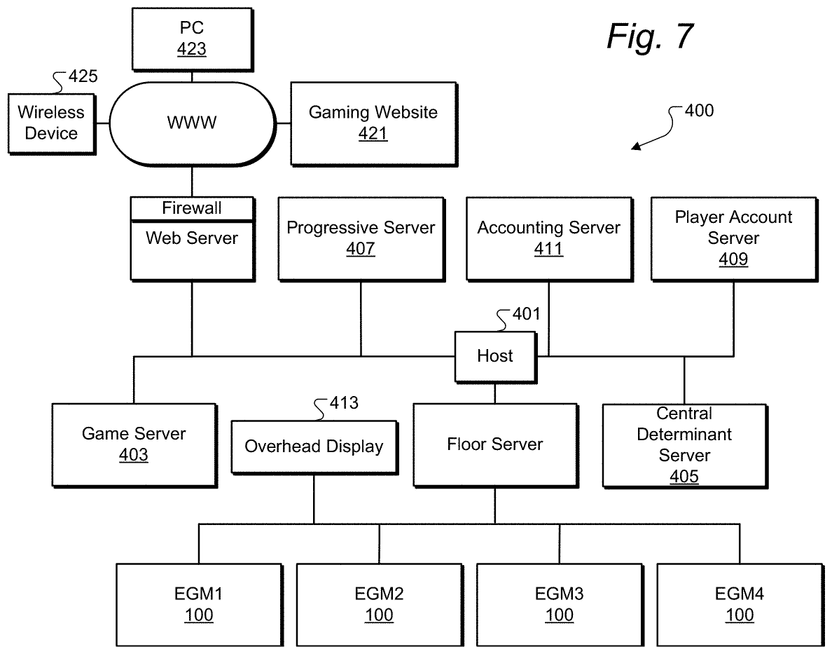

Next at block 306, the process produces or requests a game result, which may be provided by a game server 403 (FIG. 7) or a locally running game engine for providing randomized outcomes. The preferred version provides a result by generating at least one random number and uses the at least one random number to determine a set of game reel stops specifying a position in which multiple simulated or mechanical reels will stop to display symbols in a symbol array in a spin outcome for the wager. Along with requesting the outcome, block 306 begins the display of the game play presentation by starting a spin of the reels 52. This reel spin is preferably unsynchronized, and is shown to start at the normal spinning speed of the reels in ordinary play, referred to as “high-speed” to contrast with low-speed spinning described below. The diagram of FIG. 1B depicts the high-speed spinning state, in which the reels are spinning quickly as depicted by the large motion arrows 70. The depicted reel movement is not synchronized, that is the reel symbol locations 54 are not aligned in rows as the reels spin. The reels 52 may also be spinning at slightly different speeds. Each reel may begin to spin at a slightly offset time from the other reels.

Next, as shown in the decision block 308, the process determines if the game result includes a synchronized game outcome, shown as “synch feature,” which is available as a random possibility in each round of the game. The synchronized game outcome is preferably activated as a mystery award (the player cannot see a cause in the game that triggers the feature), but may also be activated by a suitable trigger. If no synchronized game outcome is included, the process goes to block 311, where the game round is conducted by concluding the spin and evaluating it according to the game's construction. If a synchronized game outcome is included, the process goes to block 310, where it determines the reel stop positions for the game result. This may be part of the game result provided already provided at block 306, or may be determined based thereon. While this determination is made, the reels remain spinning at a normal, “high speed” rate of spin typical for play of the game, such as about 20 symbols per second. Then the process will enter a low-speed spin at block 318, but first it must adjust the reel positions such that the low speed spin completes as required. Based on the stop positions, the process at block 312 determines reel offsets necessary to conduct a synchronized spin and stop at the stop positions. This typically produces an offset for all the reels, but some reels may be in the correct position not require an offset, so at a minimum the process includes determining a reel offset for at least one of the reels and usually for multiple reels. This determination is also made based on the amount of time the synchronized spin will continue, and the speed of the synchronized spin. Preferably the process calculates the offset by first finding a desired synchronized spin start position, which may be done by calculating a number of symbol positions prior to the stop position as the spin speed (symbols/second)×spin time (second)=symbols. Then the offset is calculated as a difference between the present position (or a known future position) and the desired position.

An example of producing such offsets is shown in FIG. 4, which depicts reel stop data, and reel positions before and after applying offsets to achieve the reel stops. The reel position diagrams show 20-position reels flattened into a strip, but typically a reel has many more positions than this example. Reel stop positions determined by the process in block 310 of FIG. 3 are shown in data structure 78 to be position 17, position 14, and position 19 for the three reels in this example. On the left, a diagram represents an instantaneous state of the three reels 52 before offsets 79 are applied. On the right, the diagram represents the state of the three reels 52 after the offsets 79 are applied. In this example, the process knows that a 4 second synchronized spin will occur at 2 symbols per second. The process determines that positions 5, 2, and 11 are needed at the start of the synchronized spin to produce the final stop positions 17, 14, and 19 as shown at array 51-C. This can be seen in the right hand diagram by moving down 8 symbol locations on each reel from a desired stop position of 17, 14, 19. Knowing that positions 5, 2, and 11 need to be present at the start of synchronized spin, the process then determines an offset 79 for each reel required to bring the desired location on the array 51-A at the beginning of the synchronized spin. Each depicted offset is simply the difference between the current instantaneous position (20, 13, 7 counting from the bottom row of array 51-a) and the desired position (5, 2, 11). This provides how many symbols positions back (opposite the rotation) the reel stop position needs to be at the start of the synchronized spin to provide the stop positions without any visual discontinuities during the slow spin phase. This same calculation may be applied to simulated reel or mechanical reels. Applying the reel offsets is preferably done at a transition between the unsynchronized spin and the synchronized spin.

Referring back to the flowchart of FIG. 3, at block 314 the process applies the offset to the reels, placing the reels in a desired relative position for synchronized spinning. This places the reels in the position where the matrix of symbol locations 51 is in the state shown in FIG. 4, matrix 51-B. The process may perform this application in a variety of ways in different embodiments. For simulated reels, the process may “patch” the reels, by placing a discontinuity where the reels switch from one portion of the reel layout to a different spot on the reels when the game switches its reel spin speed from fast to slow at block 316. The discontinuity is applied at such point because it is much less noticeable to the player, whereas if it were to be applied right at the end of the slow spin, near the stop of block 320, the change in symbols on the reel may be noticeable to a player, which would detract from the effect of the synchronized spin. The techniques herein provide the advantage of allowing a game outcome to start as a normal spin, and then transition to the more exciting low speed synchronized spin, while allowing the synchronized spin to be conducted without any visible discontinuities that might interfere with the player enjoyment. While the reel offsets are applied with a discontinuity in one version, the offset may be applied in other suitable ways. For example, the offset may be applied by changing the velocity of each reel for a short time period before the synchronization start at block 316, in order to arrive at the desired offset position at when the process goes to block 316. This method may also be used with mechanical reels such as those depicted in FIG. 2. In such case, applying the offset at block 314 includes controlling stepper motors to the reels to alter the position of the reels by the amount of the offset. Because the stepper motors cannot change position instantly the way simulated reels are, a change in velocity may be required to apply the offset. The change in velocity may be applied for a selected period of time for each reel to achieve the desired offset.

After the offset is applied, the process at block 316 displays the synchronization start, and then conducts the synchronized spin at a low velocity as shown at block 318. Using such a low velocity in a synchronized reel spin as according to the processes herein allows player anticipation by viewing possible winning outcomes slowly appear across the display, with the advantage of not requiring a large wheel structure like popular wheel games that include the large wheel structure. It should be noted that preferably the transition from the unsynchronized spin to the synchronized spin, and application of the offsets, is carried out while maintaining continuous motion of the reels, that is, not stopping the reels but merely slowing them from the high velocity of the unsynchronized (normal) spin to the low velocity of the synchronized spin. Block 316 may be executed in parallel to block 314. The start of the synchronized spin at block 316 may include an animation or multimedia effect to draw attention to the fact that a special feature is being activated. Next the process at block 318 includes performing a synchronized spin of the reels including moving all reels at the same speed and with symbols moving in synchronized parallel rows. Such a synchronized spin is depicted in FIG. 1C, with arrows 71 depicting motion of each reel 52 moving at the same speed in a synchronized fashion. The synchronized spin preferably includes moving the reels at a velocity at which reel stop combinations can be recognized by a player. Since players vary in age and perception, this velocity may vary, but is less than half the velocity of a normal, high-speed spin, and will typically be less than around four symbols per second. Other speeds may be used, such as less than three symbols per second, and a preferred version which has been tested to build anticipation by almost all players is two symbols per second. Of course, alternations small alterations around the two symbols per second velocity do not significantly change the perception. Preferably the speed is constant. Block 318 continues for a designated amount of time, preferably long enough for a player to see several reel stop combinations move past in synchronized fashion, allowing anticipation to build of winning patterns that may result from the synchronized spin. In a preferred version, the synchronized spins will vary in length, for example in one version a spin lasts for 4, 7, or 10 seconds. Depending on the size of the array, a certain number of reel stop combinations will be displayed during the synchronized spin. For a two-row display, for example, a 2 symbols per second speed would display 8 unique combinations in 4 seconds, 14 unique combinations in 7 seconds, and 20 unique combinations in 10 seconds. Minimally to provide the advantage of building anticipation the number of unique combinations shown during the synchronized spin should be four or more.

Next at block 320 the process performs a synchronized stop of the reels. For simulated reels the process may simply display an instant stop of the motion, or may include a slow-down before the stop. For versions with mechanical reels, some minimal deceleration period, typically far less than a second, is physically unavoidable, and may be perceptible to the player or not. Block 320 includes stopping the reels in synchronized parallel rows to rest at the reel stop locations. Next at block 322 the process evaluates the outcome for the presence of winning patterns according to the game rules. Any credit prizes due are awarded at block 324 and the process returns to block 304 where it awaits a new wager or game activation input from the player.

It should be noted that the synchronized spin feature described herein may be provided as a feature in a base game round or a bonus game. Generally, the process steps shown in FIG. 3 are performed by one or more electronic processors executing computer program code on a gaming machine or server on a gaming network. Further, the system computer program code, executable by a gaming machine or gaming network processor, as described herein are preferably executed by a Class III gaming machine which conducts all random number generation on the gaming machine itself as further discussed below. It should be understood that this is only one example embodiment, and other versions may divide the processing tasks of the game method in a different manner. For example, some systems may employ a thin client architecture in which practically all of the processing tasks are performed at the game server, and only display information for the player interface transmitted to the electronic gaming machine. In such an embodiment, only the steps involving player input or display are performed by the electronic gaming machine, with the remaining steps performed by one of the game servers in the system. In such a case, though, the software architecture is preferably designed as a thin client in which a dedicated virtual machine running on the game server (or a virtual machine server connected in the gaming network) performs the tasks designated in the present drawing as occurring “at the gaming machine.” While central processor arrangements may vary (for example award controllers may be integrated on the same machine with a gaming server, or may be a separate server connected on a secure network), the particular central determinant architecture is not limiting and will be referred to generally in this drawing as the game server. The method performed at the game server further includes receiving game play requests originating from electronic gaming machine 100, and sending commands to the gaming machine to show reels spinning, the feature game selection process, the wheel enhancement feature game, and results being displayed. The division of game logic steps between gaming machines and servers is known in the art and may be accomplished according to suitable methods allowed for the relevant gaming jurisdictions.

While a sequential flowchart is shown to describe an example process, this is not limiting, and typically a software architecture will be an object oriented design, or similar event driven design, in which user input and game process events cause software objects to perform tasks in response.

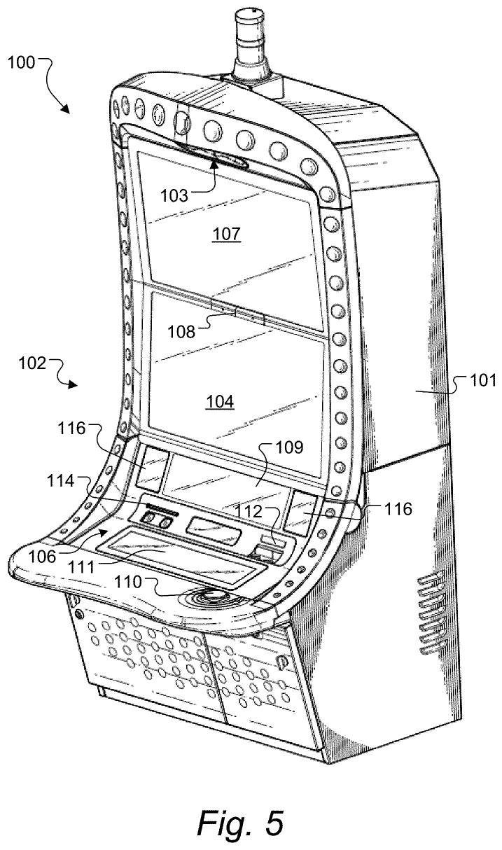

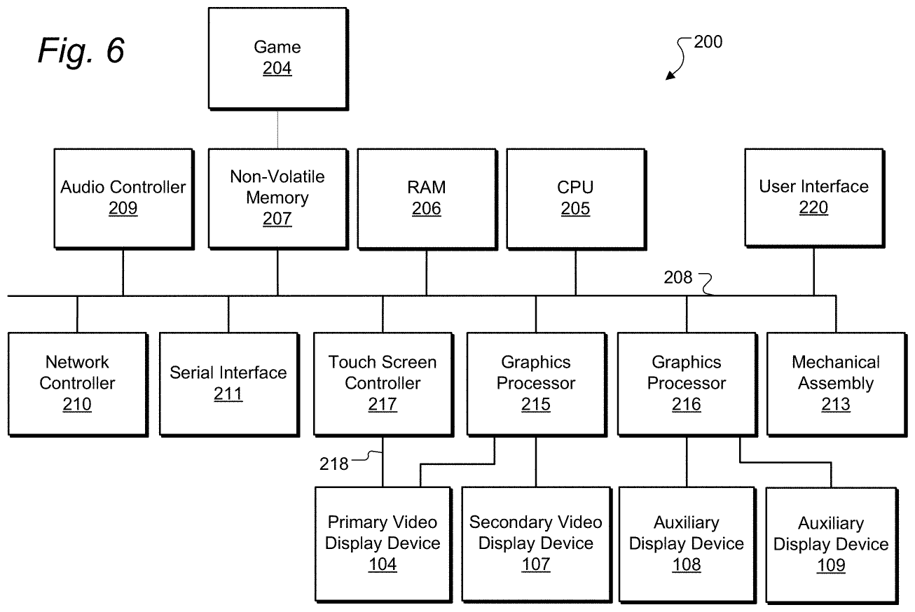

The invention may also be embodied as a gaming machine, such as the example machine depicted in FIG. 5 or the machine of FIG. 6. The particular technical architecture is not important as many special purpose gaming cabinets and gaming machines are known in the art. Generally, such versions provide a gaming machine for providing a wagering game, including a game cabinet in which is housed at least one electronic display, currency-voucher acceptor, and a player interface with buttons. The gaming machine may be constructed according to the example hardware block diagram of FIG. 6, or other suitable designs, is controlled by one or more electronic controllers coupled to the electronic display, currency-voucher acceptor and player interface, tangible non-transitory computer readable memory coupled to the controllers, the memory holding program code executable by the controllers for performing the process described above or variations thereof.

Further, some versions of the invention may be embodied as the system computer program code, executable by a gaming machine or gaming network processor, as described herein are preferably executed by a Class III gaming machine which conducts all random number generation on the gaming machine itself as further discussed below. In the depicted flowcharts, the method is performed by the respective computer hardware operating under control of computer program code stored in tangible, non-transitory memory on the gaming machine and/or one or more of the system servers in client/server or thin client embodiments. While central processor arrangements may vary (for example award controllers may be integrated on the same machine with a gaming server, or may be a separate server connected on a secure network), the particular central determinant architecture is not limiting and will be referred to generally in this drawing as the game server (i.e. 403).

FIG. 5 is a perspective view of a gaming machine 100 that may be used to implement feature games according to the present invention. The block diagram of FIG. 6 shows further details of gaming machine 100. Referring to FIG. 5, gaming machine 100 includes a cabinet 101 having a front side generally shown at reference numeral 102. A primary video display device 104 is mounted in a central portion of the front surface 102, with a ledge 106 positioned below the primary video display device and projecting forwardly from the plane of the primary video display device. In addition to primary video display device 104, the illustrated gaming machine 100 includes a secondary video display device 107 positioned above the primary video display device. One or more lamps 103 are mounted under a top lip of cabinet 101 to illuminate the ledge 106. Gaming machine 100 may also include two additional smaller auxiliary display devices, an upper auxiliary display device 108 and a lower auxiliary display device 109. It should also be noted that each display device referenced herein may include any suitable display device including a cathode ray tube, liquid crystal display, plasma display, LED display, or any other type of display device currently known or that may be developed in the future.

In preferred versions, the gaming machine 100 illustrated in FIG. 5 also includes a of mechanical control button 110 mounted toward the front right side on ledge 106, which is a play button for activating wagers and game rounds. A touch screen button interface 111 mounted centrally along the ledge 106 also presents additional control buttons which may allow a player to select a bet level, select paylines, select a type of game or game feature, for example. Such button controls may instead be provided as mechanical buttons on ledge 106. Further, primary video display device 104 in gaming machine 100 provides a convenient display device for implementing touchscreen controls. It will be appreciated that gaming machines may also include a number of other player interface devices in addition to devices that are considered player controls for use in playing a particular game. The ledge may also include a hardware special object including a button, touch sensor, or switches, joysticks, or other mechanical input devices, and/or virtual buttons and other controls implemented on a suitable touchscreen video display.

Gaming machine 100 also includes a currency/voucher acceptor having an input ramp 112, a player card reader having a player card input 114, and a voucher/receipt printer having a voucher/receipt output which may near or integrated with the currency/voucher acceptor 112 or near or integrated with the player card input 114. A pair of cash out and service buttons are positioned below player card input 114. Audio speakers 116 generate an audio output to enhance the user's playing experience. Numerous other types of devices may be included in gaming machines that may be used according to the present invention.

FIG. 6 shows a logical and hardware block diagram 200 of gaming machine 200 which includes a central processing unit (CPU) 205 along with random access memory 206 and nonvolatile memory or storage device 207. All of these devices are connected on a system bus 208 with an audio controller 209, a network controller 210, and a serial interface 211. A graphics processor 215 is also connected on bus 208 and is connected to drive primary video display device 104 and secondary video display device 107 (both mounted on cabinet 101 as shown in FIG. 5). A second graphics processor 216 is also connected on bus 208 in this example to drive the auxiliary display devices 108 and 109 also shown in FIG. 5. As shown in FIG. 6, gaming machine 200 also includes a touch screen controller 217 connected to system bus 208. Touch screen controller 217 is also connected via signal path 218 to receive signals from a touchscreen element associated with primary video display device 104. It will be appreciated that the touchscreen element itself typically comprises a thin film that is secured over the display surface of primary video display device 104. The touchscreen element itself is not illustrated or referenced separately in the figures.

Those familiar with data processing devices and systems will appreciate that other basic electronic components will be included in gaming machine 200 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 5 are known in the art of gaming cabinet and gaming machine design. Those familiar with data processing systems and the various data processing elements shown in FIG. 6 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 6 as being connected directly on system bus 208 may in fact communicate with the other system components through a suitable expansion bus. Audio controller 209, for example, may be connected to the system via a PCI bus. System bus 208 is shown in FIG. 6 merely to indicate that the various components are connected in some fashion for communication with CPU 205 and is not intended to limit the invention to any particular bus architecture. Numerous other variations in the gaming machine internal structure and system may be used without departing from the principles of the present invention.

It will also be appreciated that graphics processors are also commonly a part of modern computer systems. Although separate graphics processor 215 is shown for controlling primary video display device 104 and secondary video display device 107, and graphics processor 216 is shown for controlling both auxiliary display devices 108 and 109, it will be appreciated that CPU 205 may control all of the display devices directly without any intermediate graphics processor. The invention is not limited to any particular arrangement of processing devices for controlling the video display device included with gaming machine 200. Also, a gaming machine implementing the present invention is not limited to any particular number of video display devices or other types of display devices.

In the illustrated gaming machine 200, CPU 205 executes software which ultimately controls the entire gaming machine including the receipt of player inputs and the presentation of the graphic symbols displayed according to the invention through the display devices 104, 107, 108, and 109 associated with the gaming machine. As will be discussed further below, CPU 205 either alone or in combination with graphics processor 215 may implement a presentation controller for performing functions associated with a primary game that may be available through the gaming machine, and or may implement a game client for directing one or more display devices at the gaming machine to display present the game features herein. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs, while the nonvolatile memory or storage device 207 may comprise a hard drive or other mass storage device providing storage for programs not in use or for other data generated or used in the course of gaming machine operation. Network controller 210 provides an interface to other components of a gaming system in which gaming machine 200 is included.

Still referring to the hardware and logical block diagram 200 showing an example design for a gaming machine 100, the depicted machine in operation is controlled generally by CPU 205 which stores operating programs and data in memory 207 with wagering game 204, user interface 220, network controller 210, audio/visual controllers, and mechanical assembly 213 (if a mechanical structure is employed for the reels such as that of FIG. 2). CPU or game processor 205 may comprise a conventional microprocessor, such as an Intel microprocessor, mounted on a printed circuit board with supporting ports, drivers, memory, software, and firmware to communicate with and control gaming machine operations, such as through the execution of program code stored in memory 207 including one or more wagering games 204 such program code for the various embodiments described herein. Game processor 205 connects to user interface 220 such that a player may enter input information, and game processor 205 may respond according to its programming, such as to apply a wager and initiate execution of a game.

Game processor 205 also may connect through network controller 210 to a gaming network, such as example casino server network system 400 shown in FIG. 7. Referring now to FIG. 7, the invention may be embodied as a system including one or more gaming machines connected through a network to supporting servers such as those depicted. The casino server network system 400 may be implemented over one or more site locations and include host server 401, gaming server 403, which can also function as a remote game play server (configured to provide game processor functionality including determining game outcomes and providing audio/visual instructions to a remote gaming device), central determinant server 405 (which may be configured to determine lottery, bingo, or other centrally determined game outcomes and provide the information to networked gaming machines 100 providing lottery and bingo-based wagering games to patrons), progressive server 407 (which may be configured to accumulate a progressive pool from a portion of wagering proceeds or operator marketing funds and to award progressive awards upon the occurrence of a progressive award winning event to one or more networked gaming machines 100), player account server 409 (which may be configured to collect and store player information and/or awards and to provide player information to gaming machines 100 after receiving player identification information such as from a player card), and accounting server 411 (which may be configured to receive and store data from networked gaming machines 100 and to use the data to provide reports and analyses to an operator). Through its network connection, gaming machine 100 may be monitored by an operator through one or more servers such as to assure proper operation, and, data and information may be shared between gaming machine 100 and respective of the servers in the network such as to accumulate or provide player promotional value, to provide server-based games, or to pay server-based awards.

System 400 includes a number of gaming machines 100 in this example implementation. For purposes of describing system 400, each gaming machine 100 in FIG. 6 includes a video display device 107 and a player interface that may include buttons, switches, or other physical controls and/or touchscreen controls as discussed above in connection with FIG. 6. Other gaming cabinet, tabletop, and mobile device architectures may, of course, be used. System 400 further includes a game server 403 and a respective game client software package included with each respective gaming machine 100. In the form of the invention shown in FIG. 6, these two components, game server 403 and the game client components, combine to implement a game control arrangement which will be described in detail below. System 400 also includes a central determinant server 405, which may provide random numbers under legally regulate conditions, and is associated with game server 403, though the two servers may be implemented through a common data processing device/computer system or in separate devices. Gaming machines 100, game server 403, and central determinant servers 405 are connected through the depicted network. The present invention is not limited to any particular communications arrangement for facilitating communications between game server 403 and various gaming machines 100. Any wired or wireless communication arrangement employing any suitable communications protocols (such as TCP/IP for example) may be used in an apparatus according to the invention.

In embodiments where game results are provided over the network, or in “thin client” embodiments, the game control arrangement made up of game server 403 and the respective game client at a given gaming machine 100 functions to control the respective video display device for that gaming machine to display the base and bonus games herein. Game server 403 is responsible for awarding prizes for a player's participation in a wheel enhancement feature game, and maintaining progressive prize information where the wheel enhancement game offers one or more progressive prizes. It should be noted that the game control arrangement may be implemented in some embodiments entirely on the gaming machine. This is especially true in jurisdictions that allow Class III gaming conducted with random number generators at each gaming machine. In other embodiments, game server 403 may provide server-based games and/or game services to network connected gaming devices, such as gaming machines 100 (which may be connected by network cable or wirelessly). Progressive server 407 may accumulate progressive awards by receiving defined amounts (such as a percentage of the wagers from eligible gaming devices or by receiving funding from marketing or casino funds) and provide progressive awards to winning gaming devices upon a progressive event, such as a progressive jackpot game outcome or other triggering event such as a random or pseudo-random win determination at a networked gaming device or server (such as to provide a large potential award to players playing the community feature game). Progressive prizes may be made available to be won through the synchronized game outcome, typically requiring a qualifying bet to eligible, and may be awarded as mystery-type award or as part of a bonus. Accounting server 411 may receive gaming data from each of the networked gaming devices, perform audit functions, and provide data for analysis programs, such as the IGT Mariposa program bundle.

Player account server 409 may maintain player account records, and store persistent player data such as accumulated player points and/or player preferences (e.g. game personalizing selections or options). For example, the player tracking display may be programmed to display a player menu that may include a choice of personalized gaming selections that may be applied to a gaming machine 100 being played by the player.

In one or more embodiments, the player menu may be programmed to display after a player inserts a player card into the card reader. When the card reader is inserted, an identification may be read from the card and transmitted to player account server 409. Player account server 409 transmits player information through network controller 210 to user interface 220 for display on the player tracking display. The player tracking display may provide a personalized welcome to the player, the player's current player points, and any additional personalized data. If the player has not previously made a selection, then this information may or may not be displayed. Once the player makes a personalizing selection, the information may be transmitted to game processor 205 for storing and use during the player's game play. Also, the player's selection may be transmitted to player account server 409 where it may be stored in association with the player's account for transmission to the player in future gaming sessions. The player may change selections at any time using the player tracking display (which may be touch sensitive or have player-selectable buttons associated with the various display selections).

In one or more embodiments, a gaming website may be accessible by players, e.g. gaming website 421, whereon one or more games may be displayed as described herein and played by a player such as through the use of personal computer 423 or handheld wireless device 425 (e.g. Apple iPhone, Android phone, tablet, phablet, virtual reality device, iPad, etc.). To enter the website, a player may log in with a username (that may be associated with the player's account information stored on player account server 409 or be accessible by a casino operator to obtain player data and provide promotional offers), play various games on the website, make various personalizing selections and save the information, so that during a next gaming session at a casino establishment, the player's playing data and personalized information may be associated with the player's account and accessible at the player's selected gaming machine 100.

Referring generally to the description herein, any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U.S. patent law and any relevant foreign patent laws, for any working combination or some sub-combination of the features herein.

The above described preferred embodiments are intended to illustrate the principles of the invention, but not to limit the scope of the invention. Various other embodiments and modifications to these preferred embodiments may be made by those skilled in the art without departing from the scope of the present invention.

1. A method of providing a wagering game, the method conducted under control of one or more electronic processors to present gaming results on one or more displays on a gaming machine, the method comprising:
(a) receiving a wager activation on a player input device at the gaming machine;
(b) in response, conducting a game round concluding with a game result in which a matrix of symbol locations displayed on one of the displays is populated with randomly selected symbols presented on simulated reels or mechanical reels, the game result including a possibility of winning credits and a possibility of activating a synchronized game outcome;
(c) providing a synchronized game outcome by:
i) determining a set of reel stop locations for all reels in the display;
ii) determining reel offsets for one or more of the reels;
iii) applying the reel offsets to place the reels in a desired position for synchronized spinning;
iv) next, performing a synchronized spin of the reels including moving all reels at the same speed and with symbols moving in synchronized parallel rows;
v) while performing the synchronized spin, moving the reels at a velocity at which reel stop combinations can be recognized by a player;
vi) next, stopping the reels in synchronized parallel rows to rest at the reel stop locations; and
vii) evaluating the matrix of symbol locations.

2. The method of claim 1, further comprising, before applying the reel offsets, performing an unsynchronized spin of the reels at a velocity at least twice the synchronized spin velocity.

3. The method of claim 1, in which providing the synchronized game outcome further comprises displaying at least four different unique potential stop combinations during the synchronized spin.

4. The method of claim 1, further comprising while performing the synchronized spin, moving the reels at a constant velocity of less than three symbols per second.

5. The method of claim 2, further comprising maintaining continuous movement of the reels from the unsynchronized spin to the synchronized spin.

6. The method of claim 2, in which the unsynchronized spin of the reels has a spin velocity of at least eighteen symbols per second.

7. The method of claim 2, in which applying the reel offsets is done at a transition between the unsynchronized spin and the synchronized spin.

8. The method of claim 1, in which providing a synchronized game outcome is triggered as a mystery outcome.

9. The method of claim 1, in which determining the reel offsets comprises determining a desired reel state to begin the synchronized spin, and determining a difference between a present state and the desired reel state.

10. The method of claim 1, in which applying the reel offsets comprises altering the reels to move symbols over the reel offset to new locations.

11. The method of claim 1, in which the reels are mechanical reels, and applying the reel offsets comprises commanding respective stepper motors to rotate respective reels by the offset.

12. A gaming machine comprising:
a display system including one or more displays;
a player input system;
at least one processor operably connected to the display system and player input system; and
at least one memory device operably connected to the processor and storing program code executable by the at least one processor for:
(a) receiving a wager activation on a player input device at the gaming machine;
(b) in response, conducting a game round concluding with a game result in which a matrix of symbol locations displayed on one of the displays is populated with randomly selected symbols presented on simulated reels or mechanical reels, the game result including a possibility of winning money value credits and a possibility of activating a synchronized game outcome;
(c) providing a synchronized game outcome by:
i) determining a set of reel stop locations for all reels in the display;
ii) determining reel offsets for one or more of the reels;
iii) applying the reel offsets to place the reels in a desired position for synchronized spinning;
iv) next, performing a synchronized spin of the reels including moving all reels at the same speed and with symbols moving in synchronized parallel rows;
v) while performing the synchronized spin, moving the reels at a velocity at which reel stop combinations can be recognized by a player;
vi) next, stopping the reels in synchronized parallel rows to rest at the reel stop locations; and
vii) evaluating the matrix of symbol locations.

13. The gaming machine of claim 12, in which the program code is further executable for, before applying the reel offsets, performing an unsynchronized spin of the reels at a velocity at least twice the synchronized spin velocity.

14. The gaming machine of claim 13, in which the program code is further executable for further comprising maintaining continuous movement of the reels from the unsynchronized spin to the synchronized spin.

15. The gaming machine of claim 13, in which applying the reel offsets is done at a transition between the unsynchronized spin and the synchronized spin.

16. The gaming machine of claim 12, in which performing the synchronized spin, moving the reels at a constant velocity of less than three symbols per second.

17. The gaming machine of claim 12, in which the program code is further executable for providing the synchronized game outcome triggered as a mystery outcome.

18. The gaming machine of claim 12, in which determining the reel offsets comprises determining a desired reel state to begin the synchronized spin, and determining a difference between a present state and the desired reel state.

19. The gaming machine of claim 12, in which applying the reel offsets comprises altering the reels to move symbols over the reel offset to new locations.

20. The gaming machine of claim 12, in which the reels are mechanical reels, and applying the reel offsets comprises commanding respective stepper motors to rotate respective reels by the respective reel offset.
